(19) United States
(12) Patent Application Publication
(10) Pub. No.: US 2022/0237179 A1
(43) Pub. Date: Jul. 28, 2022

(54) Systems and Methods for Improved Machine Learning Using Data Completeness and Collaborative Learning Techniques

(71) Applicant: Wood Mackenzie, Inc., Houston, TX (US)

(72) Inventors: Yanyan Wu, Houston, TX (US); Chao Yang, Houston, TX (US); Hugh Hopewell, Houston, TX (US); Bernard Ajiboye, Houston, TX (US); Rhodri Thomas, Edinburgh (GB)

(73) Assignee: Wood Mackenzie, Inc., Houston, TX (US)

(21) Appl. No.: 17/585,977

(22) Filed: Jan. 27, 2022

Related U.S. Application Data
(60) Provisional application No. 63/142,551, filed on Jan. 28, 2021.

(51) Int. Cl. G06F 16/23

(52) U.S. Cl. CPC G06F 16/2379

(57) ABSTRACT

Systems and methods for improved machine learning using data completeness and collaborative learning techniques are provided. The system receives one or more sets of data, and classifies samples within the data into a multi-dimensional tree data structure. Next, the system identifies outliers and null values within the tree. Then, the system fills in the outliers and null values based on neighboring values. Collaborative filtering AI technology can be utilized to fill the rest of the missing values of all data attributes.

### RELATED APPLICATIONS

This application claims priority to U.S. Provisional Patent Application Ser. No. 63/142,551 filed Jan. 28, 2021, the entire disclosure of which is hereby expressly incorporated by reference.

### BACKGROUND

### Technical Field

The present disclosure relates generally to the field of machine learning. More specifically, the present disclosure relates to systems and methods for improved machine learning using data completeness and collaborative learning techniques.

### Related Art

Completeness of data is key for a variety of computer-based applications, particularly building any machine learning and deep learning model. Such models are useful in a variety of industries. For example, survey data is often modeled to analyze sites for discovering new oil or gas reserves. Further, in the investment industry, accurate information about investment options can be used to determine investment strategy.

Various software systems have been developed for processing data to build models using machine learning. Typically, outliers and null values widely exist in collected data. Conventional approaches mainly fill the null values and replace the outliers with a fixed value. The filled values may be created using statistic metrics of the data set (such as minimum, maximum, or mean), backward or forward filling with neighboring data, local regression to fill the data, or with traditional machine learning and AI technologies.

The conventional approaches are generally inaccurate and time consuming, particularly when employing a machine learning and AI-based approach. These conventional approaches also do not provide clarity as to which known attributes should be input into machine learning and AI-based approaches. As such, the ability to quickly and accurately fill in outliers and null values in data to build accurate models is a powerful tool for a wide range of professionals. Accordingly, the machine learning systems and methods disclosed herein solve these and other needs.

### SUMMARY

The present disclosure relates to systems and methods for improved machine learning using data completeness and collaborative learning techniques. The system first receives one or more sets of data. For example, the data sets can be received from an array of sensors. The system then classifies samples within the data into a multi-dimensional tree data structure. Next, the system identifies outliers and null values within the tree. Then, the system fills in the outliers and null values based on neighboring values. For example, data points close to one another in the tree data structure can be considered neighbors. In some cases, attributes may not be filled completely based on neighbors due to lack of neighbors. For these values, collaborative filtering AI technology can also be utilized to fill the rest of the missing values of all data attributes.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating overall process steps carried out by the system of the present disclosure;

FIG. 2 is a flowchart illustrating step 12 of FIG. 1 in greater detail;

FIG. 3 is a diagram illustrating a multi-dimensional tree data structure;

FIG. 4 is a flowchart illustrating step 14 of FIG. 1 in greater detail;

FIG. 5 is a flowchart illustrating step 16 of FIG. 1 in greater detail;

FIG. 6 is a diagram illustrating sample hardware components on which the system of the present disclosure could be implemented.

### DETAILED DESCRIPTION

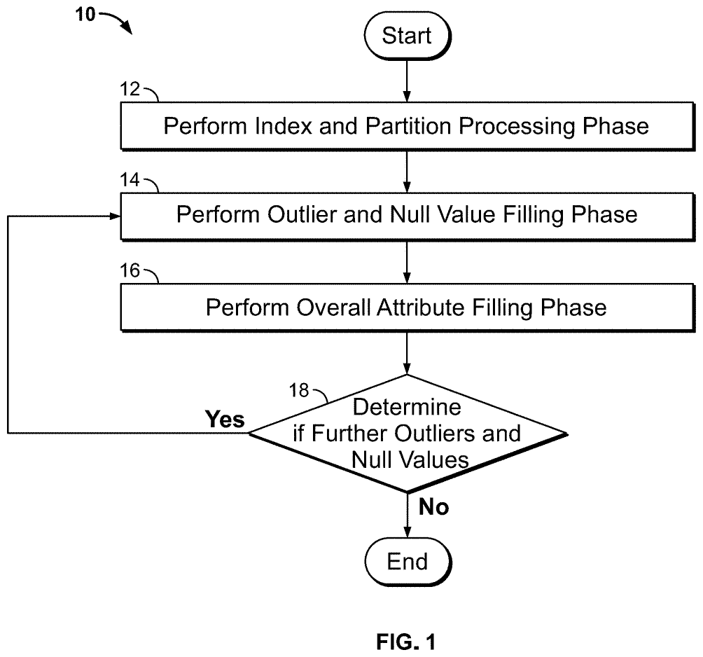

The present disclosure relates to systems and methods for improved machine learning using data completeness and collaborative learning techniques, as described in detail below in connection with FIGS. 1-6.

FIG. 1 is a flowchart illustrating the overall process steps carried out by the system, indicated generally at 10. In step 12, the system retrieves one or more sets of data (e.g., from a memory such as a database, a file, a remote data server, etc.) and performs an index and partition processing phase on the one or more sets of data. During the index and partition processing phase, the system organizes one or more set of data into a tree architecture. The one or more data sets can relate to a one or more sources of data. In an embodiment, a user, such as an energy analyst performing a well evaluation, can input attributes of well sites into the system. The user can enter the data into the system locally (e.g., at a computer system on which the present invention is implemented) or at remote computer system in communication with the present system. The entered data is processed to replace missing attributes, which will be described in greater detail below.

In step 14, the system performs an outlier and null value filling phase based on neighbor information. Specifically, the system processes the indexed and partitioned data to detects and classify one or more values in the data as either a null or a value that is outside of expected parameters, e.g., an outlier. In an embodiment, the system can detect and classify the objects in the data using artificial intelligence modeling software, such as a data tree-generating architecture, as described in further detail below. The artificial intelligence modeling software replaces the outliers and null values using data points closely associated with the outliers and null values.

In step 16, the system performs an overall attribute filling phase based on neighbor information. Specifically, the system fills in missing attributes that are not associated with the outliers and null values as will be described in further detail below. In step 18, the system determines if further outliers and/or null values exist in the data set(s). If so, the system repeats step 14. If not, the process is concluded.

The process steps of the invention disclosed herein could be embodied as computer-readable software code executed by one or more processors of one or more computer systems, and could be programmed using any suitable programming languages including, but not limited to, C, C++, C#, Java, Python or any other suitable language. Additionally, the computer system(s) on which the present disclosure can be embodied includes, but is not limited to, one or more personal computers, servers, mobile devices, cloud-based computing platforms, etc., each having one or more suitably powerful microprocessors and associated operating system(s) such as Linux, UNIX, Microsoft Windows, MacOS, etc. Still further, the invention could be embodied as a customized hardware component such as a field-programmable gate array (“FPGA”), application-specific integrated circuit (“ASIC”), embedded system, or other customized hardware component without departing from the spirit or scope of the present disclosure.

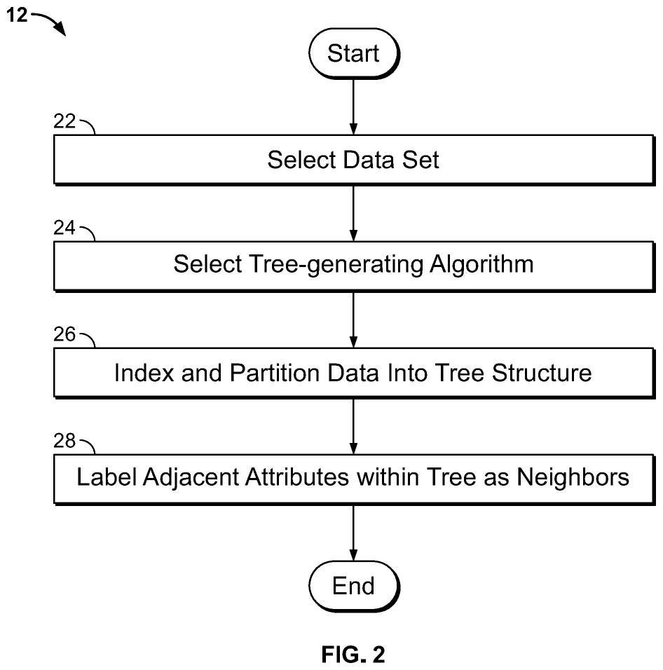

FIG. 2 is a flowchart illustrating step 12 of FIG. 1 in greater detail. In particular, FIG. 2 illustrates process steps performed during the index and partition phase. In step 22, one or more data sets are selected. The data sets contain values of physical characteristics to be examined. For example, the data sets may embody equipment performance metrics, energy resource site characteristics, sensor measurement data, human survey data, and the like. In some embodiments, noise is removed from the collected data sets.

It should be noted that during or prior to the index and partition phase, the system can use a plurality of sensors to detect one or more characteristics of one or more objects (e.g., vertical depth, lateral length, water consumption, etc. of oil well sites). Additionally or alternatively, data collected outside the system can be entered into the system for processing.

In step 24, the system selects a tree-generating algorithm. In an embodiment, the selected algorithm is a k-dimensional B-tree algorithm. In step 24, the selected data is indexed and partitioned into a tree structure. The generated tree structure may be multi-dimensional.

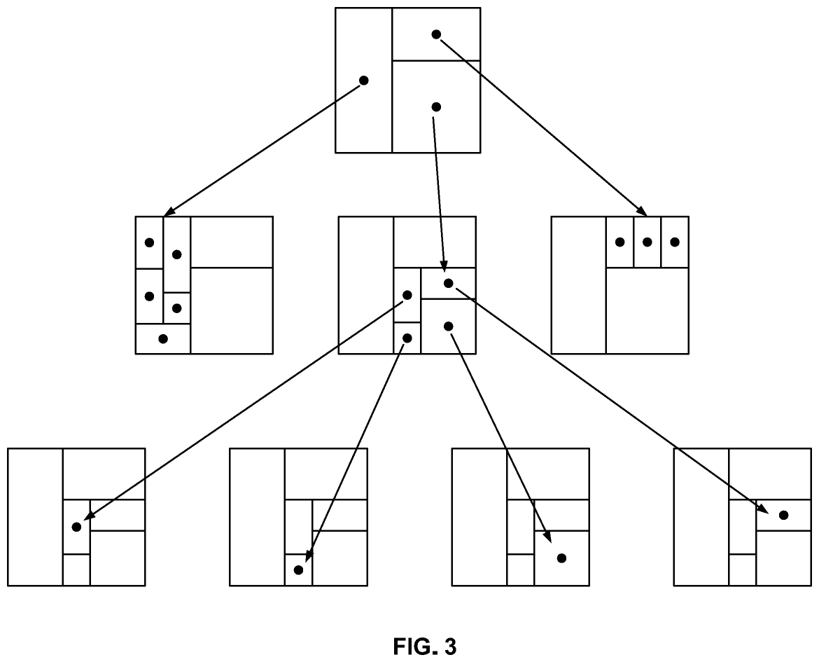

Turning briefly to FIG. 3, there is depicted an exemplary tree structure generated by the system. As can be seen in FIG. 3, the top of the “tree” depicts general attributes of an object. For example, the top level may delineate each oil well within designated area. Each attribute in the top level of the tree architecture may be broken down into further attributes in lower levels of the tree. For example, the second level of the tree could describe the “size” and “productivity” of an oil well. Attributes in levels of the tree architecture lower than the top level may be broken down into further attributes as desired. For example, the “size” attribute may be broken down into “vertical depth” and “lateral length.” The number of attributes and the number of levels of the tree architecture may be defined by the selected algorithm.

For the purposes of the above example, it the physical and categorical attributes are documented as numerical values proportional to the similarity of neighboring categories. The numerical values are also set up to provide context to the values. For example, numerical representations of a location index may be based on alphabetical order.

Returning to FIG. 2, in step 26, the system labels adjacent attributes within the tree architecture as neighbors. For example, for oil wells, the neighbor label can identify wells neighboring in physical proximity by identifying indexed data points having location attributes that are in physical proximity to one another. For sensor data, labeled neighbors can be similar sensors on the similar equipment running at the same time and under similar conditions. For data representing people or objects, labeled neighbors can be demographically identical or similar persons or objects.

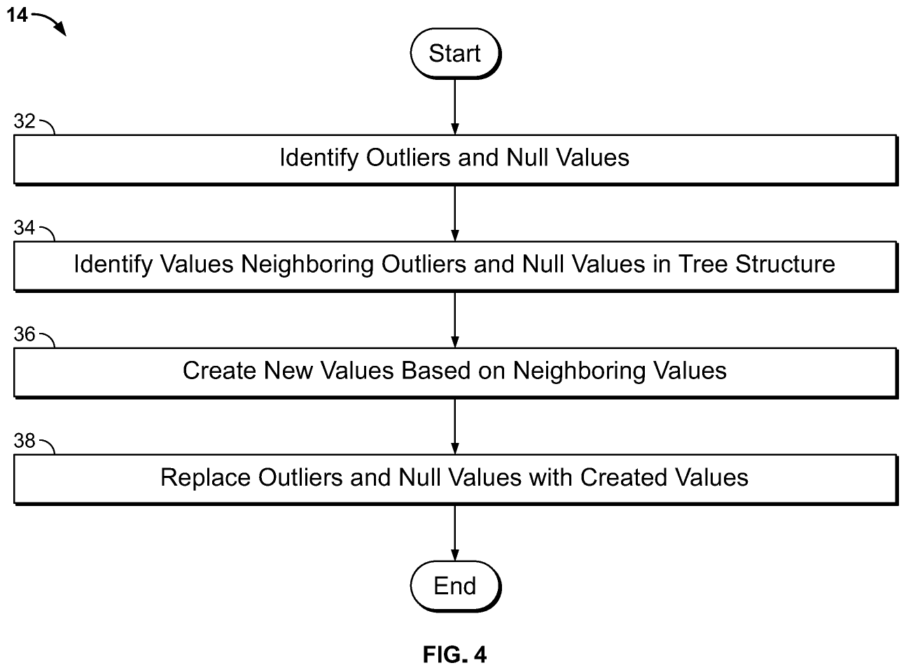

FIG. 4 is a flowchart illustrating step 14 of FIG. 1 in greater detail. In particular, FIG. 4 illustrates process steps performed during the outlier and null value filling phase. In step 32, the system identifies outliers and null values within the tree architecture. An outlier may be defined as a value that is outside of expected parameters. A value outside of expected parameters may be a value that is physically impossible (i.e., a negative value, a value higher than physically possible, a value more than an acceptable distance from the mean, etc.) or a value that lies outside of a predetermined range of parameters. A null value may be defined as an attribute lacking a value.

In step 34, the system identifies values neighboring the identified outliers and null values within the tree structure. As described above, the system labels adjacent attributes within the tree architecture as neighbors. In step 36, the system creates new values for the outliers and null values based on the values neighboring the outliers and null values. In step 38, the system replaces the outliers and null values with the created values.

Creating values based on neighboring attributes produces values that are more accurate that simply replacing outliers or null values with conventional methods, such as fixed values, using standard metrics of data (minimum, maximum, or mean values), or traditional machine learning algorithms. The values created in step 36 are the product of a collaborate approach, using multiple known attributes, rather than the product of a select few as in conventional methods. The described method also provides a quicker method for filling outliers and null values. The values are replaced in one step, e.g. step 38, rather than replacing each value sequentially as done in conventional methods.

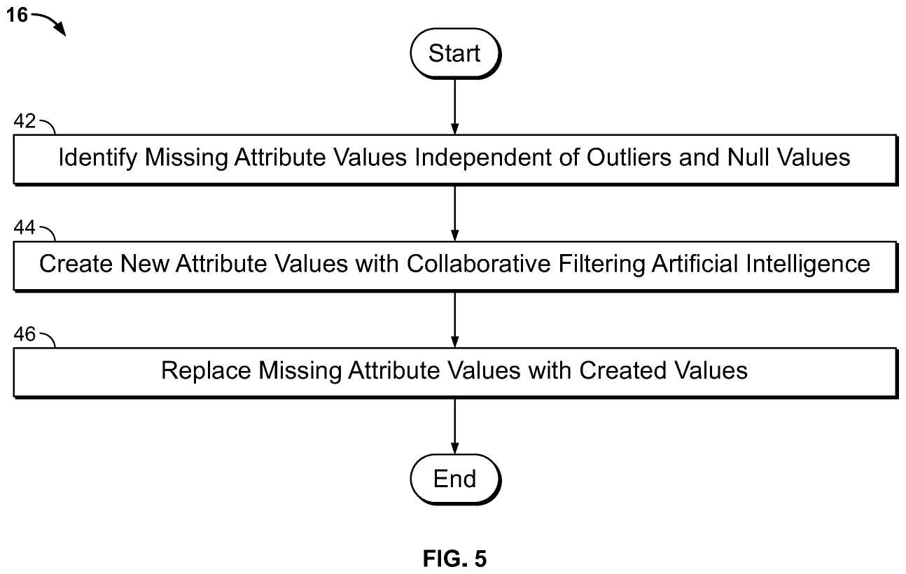

FIG. 5 is a flowchart illustrating step 16 of FIG. 1 in greater detail. In particular, FIG. 5 illustrates process steps performed during the overall attribute filling phase. In step 42, the system identifies attributes missing in the data set independent from the previously identified outliers and null values. The matrix representation below shows the concept of the matrix factorization process utilized by the system. The X matrix represents the values of all attributes. Each attribute occupies a column, where m number of objects and n number of attributes are presented. Due to the existence of noise in the attributes' values, additional feature engineering can be used to generate new attributes by grouping some of the attributes and classifying values into bins. Then, the same value can be assigned to the object that belongs to same group/bin. The S matrix represents a latent factor matrix, where the system optimizes same to achieve the best accuracy for the model parameters such as k value. Grid search can be used to fine tune these hyper parameters:

$$\begin{matrix}X \\ ( \begin{matrix}{x}_{11} & … & … & {x}_{1 n} \\ {x}_{21} & … & … & \\ ⋮ & ⋮ & ⋱ & \\ {x}_{m 1} & & & {x}_{mn}\end{matrix} ) \\ m \times n\end{matrix} \approx \begin{matrix}U \\ ( \begin{matrix}{u}_{11} & … & {u}_{1 k} \\ ⋮ & ⋱ & \\ {u}_{m 1} & & {u}_{mk}\end{matrix} ) \\ m \times k\end{matrix} \begin{matrix}S \\ ( \begin{matrix}{s}_{11} & 0 & … \\ 0 & ⋱ & \\ ⋮ & & {s}_{kk}\end{matrix} ) \\ k \times k\end{matrix} \begin{matrix}{V}^{T} \\ ( \begin{matrix}{v}_{11} & … & {v}_{1 n} \\ ⋮ & ⋱ & \\ {v}_{k 1} & & {v}_{kn}\end{matrix} ) \\ k \times n\end{matrix}$$

In step 44, the system creates new attribute values to fill missing attributes identified in step 42 using collaborative filtering artificial intelligence, as described above. In step 46, the missing attributes are filled with the created values.

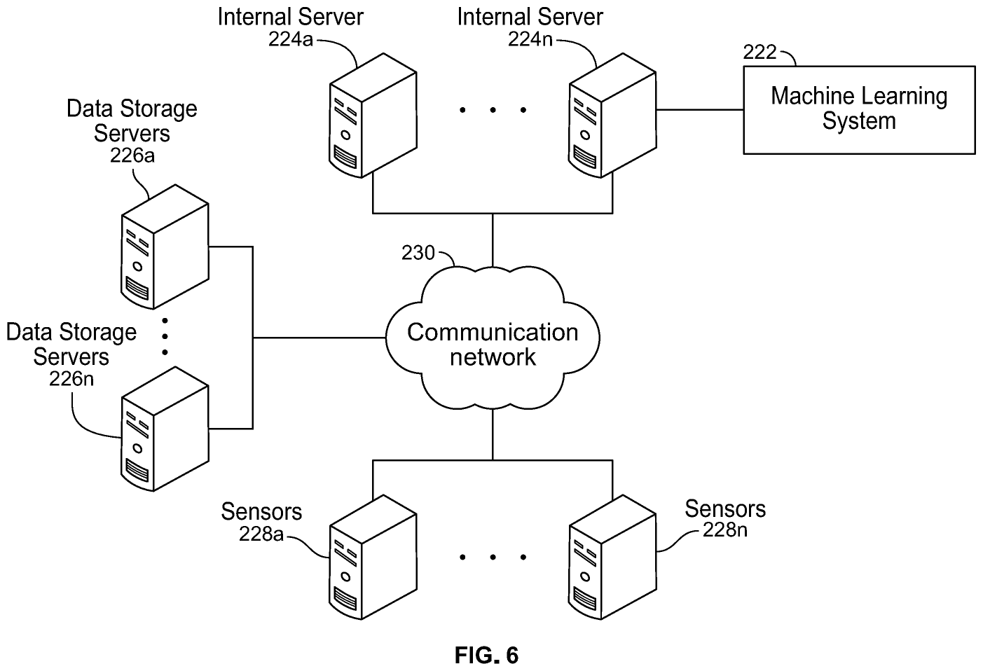

FIG. 6 is a diagram illustrating computer hardware and network components on which the system of the present disclosure could be implemented. The system can include a plurality of internal servers 224a-224n having at least one processor and memory for executing the computer instructions and methods described above (which could be embodied as machine learning or deep learning software 222 illustrated in the diagram). The system can also include a plurality of data storage servers 226a-226n for receiving data to be processed. The system can also include a plurality of sensors 228a-228n for capturing data to be processed. These systems can communicate over a communication network 230. The machine learning or deep learning software/algorithms can be stored on the internal servers 224a-224n or on an external server(s). Of course, the system of the present disclosure need not be implemented on multiple devices, and indeed, the system could be implemented on a single computer system (e.g., a personal computer, server, mobile computer, smart phone, etc.) without departing from the spirit or scope of the present disclosure. Additionally, the system could be implemented using one or more cloud-based computing platforms.

### Example 1

One of the advantages of the system disclosed herein is that it quickly bridges the completeness of data sets having large sizes (e.g., data sets gigabytes in size, and greater). In this regard, the described system was employed to fill null values in oil well attribute data. Attributes included well vertical depth, lateral length, water and proppant consumed in oil extraction operations. Data for 314,000 wells were analyzed. 145 million neighbor attributes were identified by the system within 5 minutes of processing using a tree-generating algorithm. By comparison, a single computer using a geo indexing method required 30 minutes to identify neighboring characteristics within the same data set. The geo indexing method failed frequently because the process ran out of computing resources.

Collaborative AI filtering, as described in step 44, was also employed to analyze the 314,000 oil wells. Main attributes of the wells were identified in 4 minutes. By comparison, a traditional approach employing building regression with conventional machine learning and artificial intelligence models required 2 hours to fill null values. Collaborative AI filtering was also found to be 20% more accurate in filling the null values.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for improved machine learning, comprising:
a memory storing one or more sets of data; and
a processor in communication with the memory, the processor performing the steps of:
receiving the one or more sets of data from the memory;
processing the one or more sets of data to classify samples within the one or more sets of data into a tree data structure;
processing the tree data structure to identify outliers and null values within the tree data structure;
updating the tree structure by filling in the outliers and the null values based on neighboring values in the tree data structure; and
storing the updated tree structure.

2. The system of claim 1, wherein the one or more sets of data comprises data corresponding to one or more of physical characteristics to be examined, well characteristics, performance metrics, energy resource site characteristics, sensor measurement data, or human survey data.

3. The system of claim 1, wherein the processor performs the step of filtering noise from the one or more data sets.

4. The system of claim 1, wherein the processor performs the step of updating the tree structure by identifying data having location attributes that are in physical proximity to one another.

5. The system of claim 1, wherein the processor performs the step of updating the tree structure by identifying data generated by similar sensors.

6. The system of claim 5, wherein the similar sensors operate at the same time and under similar conditions.

7. The system of claim 1, wherein the processor performs the step of updating the tree structure by identifying demographically identical or similar persons or objects.

8. The system of claim 1, wherein the processor performs the step of updating the tree structure using a matrix factorization process.

9. The system of claim 1, wherein the step of processing the one or more sets of data to classify samples within the one or more sets of data into the tree data structure is performed by indexing and partitioning of the one or more sets of data.

10. The system of claim 9, wherein the step of processing the one or more sets of data to classify samples within the one or more sets of data into the tree data structure is performed using a k-dimensional B-tree algorithm.

11. A method for improved machine learning, comprising the steps of:
receiving by a processor one or more sets of data from a memory;
processing the one or more sets of data to classify samples within the one or more sets of data into a tree data structure;
processing the tree data structure to identify outliers and null values within the tree data structure;
updating the tree structure by filling in the outliers and the null values based on neighboring values in the tree data structure; and
storing the updated tree structure in the memory.

12. The method of claim 11, wherein the one or more sets of data comprises data corresponding to one or more of physical characteristics to be examined, well characteristics, performance metrics, energy resource site characteristics, sensor measurement data, or human survey data.

13. The method of claim 11, further comprising filtering noise from the one or more data sets.

14. The method of claim 11, further comprising updating the tree structure by identifying data having location attributes that are in physical proximity to one another.

15. The method of claim 11, further comprising updating the tree structure by identifying data generated by similar sensors.

16. The method of claim 15, wherein the similar sensors operate at the same time and under similar conditions.

17. The method of claim 11, further comprising updating the tree structure by identifying demographically identical or similar persons or objects.

18. The method of claim 11, further comprising updating the tree structure using a matrix factorization process.

19. The method of claim 11, further comprising indexing and partitioning the one or more sets of data.

20. The method of claim 19, wherein the step of processing the one or more sets of data to classify samples within the one or more sets of data into the tree data structure is performed using a k-dimensional B-tree algorithm.
